(19) United States
(12) Patent Application Publication
(10) Pub. No.: US 2016/0371533 A1
(43) Pub. Date: Dec. 22, 2016

(54) METHOD FOR RECOGNIZING OPERATION BODY'S CHARACTERISTIC INFORMATION, ELECTRONIC APPARATUS, SAFETY APPARATUS AND PALM PRINT RECOGNIZING DEVICE

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Yingming Liu, Beijing (CN); Xue Dong, Beijing (CN); Haisheng Wang, Beijing (CN); Xiaochuan Chen, Beijing (CN); Xiaoliang Ding, Beijing (CN); Shengji Yang, Beijing (CN); Weijie Zhao, Beijing (CN); Lei Wang, Beijing (CN); Changfeng Li, Beijing (CN); Wei Liu, Beijing (CN)

(73) Assignees: BOE TECHNOLOGY GROUP CO., LTD., Beijing (CN); BEIJING BOE OPTOELECTRONICS TECHNOLOGY CO., LTD., Beijing (CN)

(21) Appl. No.: 15/022,421

(22) PCT Filed: Nov. 3, 2015
(86) PCT No.: PCT/CN2015/093701

§ 371 Date: Mar. 16, 2016

(30) Foreign Application Priority Data
Jun. 16, 2015 (CN) 201510333850.8

(51) Int. Cl. G06K 9/00; G06F 3/041

(52) U.S. Cl. CPC G06K 9/00087; G06F 3/0416

(57) ABSTRACT

An operation body's feature information recognition method includes: acquiring pressing signals upon a user's operation body pressing a touch screen of an electronic apparatus; determining a pressing area of the operation body according to the pressing signals; determining whether the pressing duration of the operation body pressing area exceeds a preset duration; if the pressing duration exceeds a preset duration, determining feature information of the operation body corresponding to the pressing area; and matching the feature information of the operation body with feature information stored locally to obtain a recognition result. The method simplifies the process of recognizing operation body's feature information palm, and improves the efficiency and accuracy of palm feature information recognition. An electronic apparatus, a safety apparatus and a palm print recognition device are also provided.

### TECHNICAL FIELD

Embodiments of the present disclosure relate to a method for recognizing operation body's characteristic information, an electronic apparatus, a safety apparatus and a palm print recognizing device.

### BACKGROUND

With the rapid development of information technology, information safety has attracted more and more attention. In actual life, identities of people need to be recognized accurately in checking-in, computer logging-on, etc. Biometric recognition technology has received more and more attention due to its reliability and convenience and has been widely applied in various identity authentication scenarios. Biometric recognition features primarily used at present are classified into two categories. One category is physiological characteristics such as fingerprint, palm print, iris, and human face. Another category is the behavior features such as signature and voice. As compared to other biometric recognition technology, palm print recognition technology has advantages such as high accuracy, low equipment price, and convenient usage, and thereby has received more and more attention. With the continuous improvement and optimization of palm print recognition technology, more and more palm print recognition systems have been put into practical applications.

A current palm print recognition method mainly includes a image controller (Charge-coupled Device, CCD) light image extraction method, in which recognition is achieved by four processes, namely CCD image acquisition, palm print feature extraction, storage of characteristic data, and characteristic value comparison and matching. According to the light total reflection principle, this method obtains characteristic information by acquiring images of a palm print with CCD and image information extraction, then obtaining clear palm print images by information processing such as filtering, image enhancement, thereby converting them into characteristic data.

In addition, the current palm print recognition may also be achieved by detection method such as infrared light. However, in the practical palm print recognition process, the process of acquiring palm print data is relatively complex, and the data needs to be acquired part by part.

In general, the palm print recognition process is relatively complex and the efficiency and accuracy of palm print recognition are both low.

### SUMMARY

According to an aspect of the present disclosure, there is provided a operation body feature information recognition method including: acquiring pressing signals upon a user's operation body pressing a touch screen of an electronic apparatus; determining a pressing area of the operation body according to the pressing signals; determining whether the pressing duration of the operation body pressing area exceeds a preset duration; if the pressing duration exceeds a preset duration, determining feature information of the operation body corresponding to the pressing area; and matching the feature information of the operation body with feature information stored locally to obtain a recognition result.

For example, for the step of matching feature information of the operation body with feature information stored locally to obtain a recognition result, when the operation body's feature information does not matches the locally stored feature information, the position information corresponding to the pressing area is determined; and touch signals are generated according to the position information.

For example, the touch screen includes a plurality sets of sensing signal lines and a plurality sets of driving signal lines corresponding to the plurality sets of sensing signal lines, and the step of acquiring pressing signals of a user's operation body pressing a touch screen of electronic apparatus includes: acquiring signal values on the plurality sets of sensing signal lines; acquiring signal values on the plurality sets of driving signal lines; when signal values on each set of sensing signal lines in the plurality sets of sensing signal lines and the driving signal lines corresponding to the set of sensing signal lines are different, determining that the operation body is pressing the touch screen; generating pressing signals according to the position information that signal values on each set of sensing signal lines in the plurality sets of sensing signal lines and the driving signal lines corresponding to the set of sensing signal lines are different.

For example, the touch screen includes a plurality sets of sensing signal lines and a plurality sets of driving signal lines corresponding to the plurality sets of sensing signal lines, the step of determining operation body's feature information corresponding to the operation body's pressing area when the pressing duration exceeds a preset duration includes: determining the operation body's feature information according to capacitance value variation of capacitance between each sensing signal line corresponding to the operation body's pressing area and the driving signal line corresponding to the sensing signal line.

For example, the electronic apparatus further includes a first multiplexer and a second multiplexer, and when it is determined that an operation body is pressing the touch screen, the method further includes: transmitting driving signals to the first multiplexer; transmitting sensing signals to the second multiplexer; controlling each sensing signal line in the touch screen to receive the sensing signals via the first multiplexer; controlling each driving signal line in the touch screen to receive the driving signals via the second multiplexer.

For example, the electronic apparatus further includes a first multiplexer and a second multiplexer, and when it is determined that the operation body's pressing duration exceeds a preset duration, the method further includes: acquiring a pressing area of the operation body; transmitting driving scanning signals to the first multiplexer connected with the driving signal line corresponding to the pressing area; transmitting sensing scanning signals to the second multiplexer connected with the sensing signal line corresponding to the pressing area; scanning the driving signal lines that receive the driving scanning signals via the first multiplexer in turn; scanning the sensing signal lines that receive the sensing scanning signals via the second multiplexer in turn; receiving scanning signals fed back by the sensing signal lines and the driving signal lines; determining variation of capacitance values of capacitances between the sensing signal line and the driving signal line according to the fed back scanning signals.

For example, the electronic apparatus further comprises a first multiplexer and a second multiplexer, the touch screen comprises a plurality sets of sensing signal lines and a plurality sets of driving signal lines corresponding to the plurality sets of sensing signal lines, the method further includes: when the touch screen does not receives the operation body's pressing signals, receiving low level signals with the first multiplexer and the second multiplexer; grounding the sensing signal lines and the driving signal lines in the touch screen; displaying information with the touch screen.

For example, the operation body includes a palm or a finger, and the operation body's feature information comprises: main lines, folds, mastoid process texture, fine nodes or trigonometric point of the palm or texture of the finger.

According to another aspect of the present disclosure, there is further provided an electronic apparatus including: a touch screen; a memory configured for storing computer program instructions; a processor configured for performing the computer program instructions stored in the memory to carry out steps of: acquiring pressing signals upon a user's operation body pressing a touch screen of an electronic apparatus; determining a pressing area of the operation body according to the pressing signals; determining whether a pressing duration for which the operation body presses the pressing area exceeds a preset duration; if the pressing duration exceeds the preset duration, determining feature information of the operation body corresponding to the pressing area; matching the feature information of the operation body with feature information stored locally to obtain a recognition result.

For example, when the operation body's feature information does not matches the locally stored feature information, the position information corresponding to the pressing area is determined; and touch signals are generated according to the position information.

For example, the touch screen includes a plurality sets of sensing signal lines and a plurality sets of driving signal lines corresponding to the plurality sets of sensing signal lines, the acquiring pressing signals of a user's operation body pressing a touch screen of an electronic apparatus includes: acquiring signal values on the plurality sets of sensing signal lines; acquiring signal values on the plurality sets of driving signal lines; determining that the operation body is pressing the touch screen if signal values on each set of sensing signal lines in the plurality sets of sensing signal lines and driving signal lines corresponding to the set of sensing signal lines are different; generating the pressing signals according to the position information indicating signal values on each set of sensing signal lines in the plurality sets of sensing signal lines and driving signal lines corresponding to the set of sensing signal lines are different.

For example, the touch screen includes a plurality sets of sensing signal lines and a plurality sets of driving signal lines corresponding to the plurality sets of sensing signal lines, the determining operation body's feature information corresponding to the operation body's pressing area when the pressing duration exceeds the preset duration includes: determining the operation body's feature information according to the variation magnitude of capacitance values of capacitance between each sensing signal line corresponding to the operation body pressing area and a driving signal line corresponding to the sensing signal line.

For example, the electronic apparatus further includes a first multiplexer and a second multiplexer, and when it is determined that the operation body is pressing the touch screen, the following steps are executed when the processor is running: transmitting driving signals to the first multiplexer; transmitting sensing signals to the second multiplexer; controlling each sensing signal line in the touch screen to receive the sensing signals via the first multiplexer; controlling each driving signal line in the touch screen to receive the driving signals via the second multiplexer.

For example, the electronic apparatus further includes a first multiplexer and a second multiplexer, and when determining that the operation body pressing duration exceeds the preset duration, the following steps are further executed when the processor is running: acquiring a pressing area of the operation body; transmitting driving scanning signals to the first multiplexer connected with the driving signal line corresponding to the pressing area; transmitting sensing scanning signals to the second multiplexer connected with the sensing signal line corresponding to the pressing area; scanning the driving signal lines that receive the driving scanning signals via the first multiplexer in turn; scanning the sensing signal lines that receive the sensing scanning signals via the second multiplexer in turn; receiving scanning signals fed back by the sensing signal lines and the driving signal lines; determining variation of capacitance values of capacitances between the sensing signal line and the driving signal line according to the fed back scanning signals.

The electronic apparatus further comprises a first multiplexer and a second multiplexer, the touch screen comprises a plurality sets of sensing signal lines and a plurality sets of driving signal lines corresponding to the plurality sets of sensing signal lines, the processor, while running, further carries out steps of: when the touch screen does not receives the operation body's pressing signals, receiving low level signals with the first multiplexer and the second multiplexer; grounding the sensing signal lines and the driving signal lines in the touch screen; displaying information with the touch screen.

According to yet another aspect of the present disclosure, there is provided a safety apparatus including a touch screen.

For example, the touch screen includes: a black matrix, a driving electrode layer and a sensing electrode layer, the driving electrode layer located over the black matrix; the sensing electrode layer located over the driving electrode layer; and the driving electrode layer and the sensing electrode layer being insulated from each other.

For example, the driving electrode layer includes a plurality sets of driving signal lines arranged in a first direction; the sensing electrode layer includes a plurality sets of sensing signal lines arranged in a second direction.

For example, the first direction and the second direction are perpendicular to each other.

For example, the safety apparatus further includes: a first multiplexer, a second multiplexer and a digital chip connected with the first multiplexer and the second multiplexer, the touch screen comprises a plurality sets of sensing signal lines and a plurality sets of driving signal lines corresponding to the plurality sets of sensing signal lines, driving signal lines are connected with the first multiplexer, sensing signal lines are connected with the second multiplexer, when the safety apparatus implements display function, the digital chip controls the driving signal lines, via the first multiplexer, to be grounded, and the digital chip controls the sensing signal lines, via the second multiplexer, to be grounded; when the safety apparatus implements touch function, the digital chip controls driving signal lines to receive driving signals via the first multiplexer, and the digital chip controls the sensing signal lines to receive sensing signals via the second multiplexer; when the safety apparatus implements the operation body's feature information recognition function, the digital chip controls driving signal lines to receive driving scanning signals via the first multiplexer, and the digital chip controls sensing signal lines to receive sensing scanning signals via the second multiplexer.

According to yet another aspect of the present disclosure, there is further provided a palm print recognition device, wherein the device includes: a determining unit configured for acquiring palm pressing signals, determining a palm pressing area according to the palm pressing signals and determining whether the pressing duration of the palm pressing area exceeds a preset duration; a palm print recognition unit configured for determining feature information corresponding to the palm pressing area if a pressing duration of the palm pressing area exceeds a preset duration, wherein the palm print recognition succeeds when it is determined that the palm's feature information matches the feature information stored locally; and a touch unit for, when the pressing duration of the palm pressing area does not exceeds the preset duration, determining touch position corresponding to the palm pressing area.

For example, the determining unit acquires palm pressing signals and determines a palm pressing area according to the palm pressing signals, the determining unit is configured to, while acquiring signal values on a plurality sets of sensing signal lines and each set of sensing signal lines in the plurality sets of sensing signal lines and the driving signal lines corresponding to the sensing signal lines have different signal values, determine that a palm pressing occurs and acquire a palm pressing area by positions of the plurality sets of sensing signal lines.

For example, in each set of sensing signal lines, a plurality of sensing signal lines are connected by a second multiplexer to provide a width of 3 mm-5 mm; and in each set of driving signal lines, a plurality of driving signal lines are connected by a first multiplexer to provide a width of 3 mm-5 mm.

For example, when the pressing duration of the palm pressing area exceeds the preset duration, the palm print recognition unit determines palm feature information corresponding to the palm pressing area, the palm print recognition unit is configured to, if the pressing duration of the palm pressing area exceeds a preset duration, control a plurality of sensing signal lines connected with the second multiplexer to connect sensing scanning signals in turn, and control a plurality of driving signal lines connected with the first multiplexer to connect driving scanning signals in turn; determine information on valleys and ridges of palm according to the variation magnitude of capacitance values of capacitance between a sensing signal line corresponding to the palm pressing area and the driving signal line corresponding to the sensing signal line; according to the information on valleys and ridges of palm, determine the palm's feature information, wherein the feature information of palm includes: main lines, folds, mastoid process texture, fine nodes and trigonometric point information.

For example, the device further includes: an alarm unit configured to, when it is determined that the palm feature information does not match the locally stored feature information, determine that the palm print recognition fails, and when the palm print recognition fails for times exceeding a preset value, trigger an alarm.

For example, the device further includes: a display unit for displaying information that needs to be displayed when no palm pressing signal is received.

According to yet another aspect of the present disclosure, there is provided a safety apparatus including the palm print recognition device and a touch screen.

Embodiments of the present disclosure can both implement operation body's feature information and implement touch control, and improves the efficiency and accuracy of feature information recognition by determining the operation body's pressing area first and then determining operation body's feature information. In addition, in embodiments of the present disclosure, the operation body's pressing area is determined according to a plurality sets of sensing signal lines and the driving signal lines corresponding to the set, then each corresponding sensing signal line in the operation body pressing area and driving signal line corresponding to the sensing signal line are scanned, and the feature information of the operation body pressing area is determined, which omits the process of repeated scanning of each sensing signal line and each driving signal line in the touch screen, thereby simplifying the operation body feature information recognition process.

### BRIEF DESCRIPTION OF DRAWINGS

In order to explain the technical solution of embodiments of the present disclosure more clearly, accompanying drawings of the embodiments will be introduced briefly below. Obviously, the accompanying drawings in the following description only relate to some embodiments of the present disclosure rather than limiting the present disclosure.

FIG. 1A is a flowchart of a palm print recognition method provided in an embodiment of the present disclosure;

FIG. 1B is a flowchart of an operation body information recognition method provided in an embodiment of the present disclosure;

FIG. 2 is a plan view of valleys and ridges in a palm print provided in an embodiment of the present disclosure;

FIG. 3 is a plan view of characteristic information of a palm print provided in an embodiment of the present disclosure;

FIG. 4 is a diagram of a registration phase and a palm print recognition phase provided in an embodiment of the present disclosure;

FIG. 5A is a structural representation of a palm print recognition device provided in an embodiment of the present disclosure;

FIG. 5B is a structural representation of an electronic apparatus and a safety apparatus provided in an embodiment of the present disclosure;

FIG. 6 is a structural representation of the safety apparatus provided in an embodiment of the present disclosure;

FIG. 7 is a diagram of a cross-section structure of a touch screen provided in an embodiment of the present disclosure; and

FIG. 8 is a structure top view of a touch screen provided in an embodiment of the present disclosure.

### DETAILED DESCRIPTION

In order to make objects, technical proposal and advantages of the embodiments of the disclosure apparent, the present disclosure will be described further in detail in connection with the drawings. Apparently, the described embodiments are just a part but not all of the embodiments of the disclosure. Based on the embodiments of the present disclosure, those skilled in the art can obtain all other embodiment(s), without any inventive work, which should be within the scope of the disclosure.

Embodiments of the present disclosure provide a method and a device for recognizing operation body's features, and a safety apparatus for both recognizing operation body's features and implementing touch control, as well as improving efficiency and accuracy of recognizing operation body's features. Furthermore, one embodiment of the present disclosure more specifically provides a palm print recognition method and device, a safety apparatus for implementing palm print recognition and realizing touch control, as well as improving efficiency and accuracy of palm print recognition.

Technical proposals provided in embodiments of the present disclosure will be described below with reference to accompanying drawings. Embodiments of the present disclosure describe an operation body's characteristic information recognition method and a device mainly by means of palm prints as examples. Those skilled in the art should understand that other operation body's feature recognition (such as fingerprint identification) will be similar to the method described below, which will be within the scope of the present disclosure.

It is to be noted that materials for sensing signal lines and driving signal lines in embodiments of the present disclosure are the same as those for the driving electrodes in current display panels, which will not be limited in the present disclosure. Signals over driving signal lines and sensing signal lines in embodiments of the present disclosure are electrical signals respectively, with the driving signal lines configured for transmitting electrical signals and the sensing signal lines configured for receive electrical signals. Each set of sensing signal lines include a plurality of sensing signal lines arranged equidistantly laterally or vertically, and each set of driving signal lines include a plurality of driving signal lines equidistantly laterally or vertically.

### Embodiment I

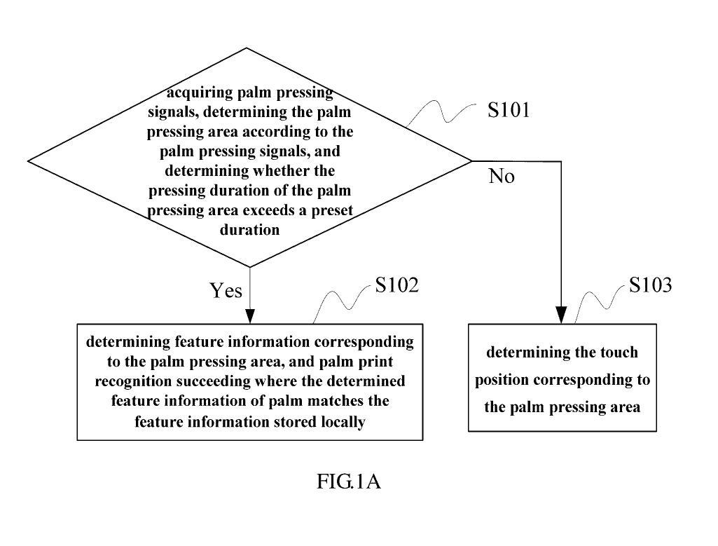

With referring to FIG. 1A, a palm print recognition method provided in an embodiment of the present disclosure includes the following steps:

S101, acquiring palm pressing signals, determining the palm pressing area according to the palm pressing signals, and determining whether the pressing duration of the palm pressing area exceeds a preset duration, if so, executing step S102, otherwise executing step S103;

S102, determining feature information corresponding to the palm pressing area, and palm print recognition succeeding where the determined feature information of palm matches the feature information stored locally;

S103, determining the touch position corresponding to the palm pressing area.

It is to be noted that the preset duration is set by a user according to actual requirement, and may be set to 2 s (second) or 3 s. Or alternatively, no specific limitation is imposed by the embodiments of the present disclosure.

In step S101, a palm pressing signal is acquired and a palm pressing area is determined according to the palm pressing signal. For example, in the case where signal values on a plurality sets of sensing signal lines are acquired and each set of sensing signal lines in the plurality sets of sensing signal lines and the driving signal lines corresponding to the sensing signal lines have different signal values, it is determined that there is a palm pressing and the palm pressing area is acquired by positions of the plurality sets of sensing signal lines.

For example, in each set of sensing signal lines, a plurality of sensing signal lines are connected by a second multiplexer to provide a width of 3 mm-5 mm. In each set of driving signal lines, a plurality of driving signal lines are connected by a first multiplexer to provide a width of 3 mm-5 mm.

For example, while scanning each set of driving signal lines and each set of sensing signal lines, when it is detected that electrical signals received on a set of sensing signal lines are different from electrical signal values transmitted on driving signal lines corresponding to this set of sensing signal lines, it is determined that there is a palm pressing. The palm pressing area is determined according to specific positions where electrical signal values on the scanned plurality sets of sensing signal lines are different from those on driving signal lines corresponding to each set of sensing signal lines.

In case of “yes” in step S102, the palm's feature information corresponding to the palm pressing area is determined. For example, if the pressing duration of the palm pressing area exceeds a preset duration, a set of sensing signal lines connected with the second multiplexer are controlled to connect sensing scanning signals in turn, and a set of driving signal lines connected with the first multiplexer are controlled to connect driving scanning signals in turn. Information on valleys and ridges of palm is determined according to the variation magnitude of capacitance values of capacitance produced between each sensing signal line corresponding to the palm pressing area and the driving signal line corresponding to the sensing signal line. According to the information on valleys and ridges of palm, the palm's feature information is determined, here the feature information of palm includes: main lines, folds, mastoid process texture, fine nodes and/or trigonometric point information, etc. The finger's feature information includes texture information of the finger.

For example, while scanning the signal values on each sensing signal line and driving signal line corresponding to the palm pressing area, if the capacitance value formed by a sensing signal line and a driving signal line corresponding to the sensing signal line becomes small and the capacitance value is less than or equal to a preset capacitance value, it is determined it's a ridge of the palm. When the capacitance value formed by a sensing signal line and a driving signal line corresponding to the sensing signal line becomes small and the capacitance value is greater than or equal to a preset capacitance value, it is determined it's the palm's valley. Here, the preset capacitance value is for example the average value of the sum of the capacitance value between a sensing signal line and a driving signal line corresponding to the sensing signal line in the case of a ridge of palm pressing the touch panel and the capacitance value between a sensing signal line and a driving signal line corresponding to the sensing signal line in the case of a valley of palm pressing the touch panel. The magnitude of the preset capacitance value is determined in practical applications and will not be limited specifically in embodiments of the present disclosure. According to positions of valleys and ridges of the palm, information such as main lines, folds, mastoid process texture, fine nodes and/or trigonometric points, etc.

With referring to FIG. 1B, an operation body feature information recognition method is further provided in an embodiment of the present disclosure that includes the following steps:

S110, acquiring pressing signals when a user's operation body presses the touch screen of an electronic apparatus;

S120, determining a pressing area of the operation body according to the pressing signals;

S130, determining whether a pressing duration for which the operation body presses the pressing area exceeds a preset duration;

S140, if the pressing duration exceeds a preset duration, determining feature information of the operation body corresponding to the pressing area; and

S150, matching the feature information of the operation body with feature information stored locally to obtain a recognition result.

It is to be noted that the palm print recognition method as illustrated in FIG. 1A may be one implementation of a operation body feature information recognition method, however the present disclosure is not limited thereto. As described above, the above-mentioned method may also be applied to other operation body's information such as fingerprints or the like in addition to application to palm prints.

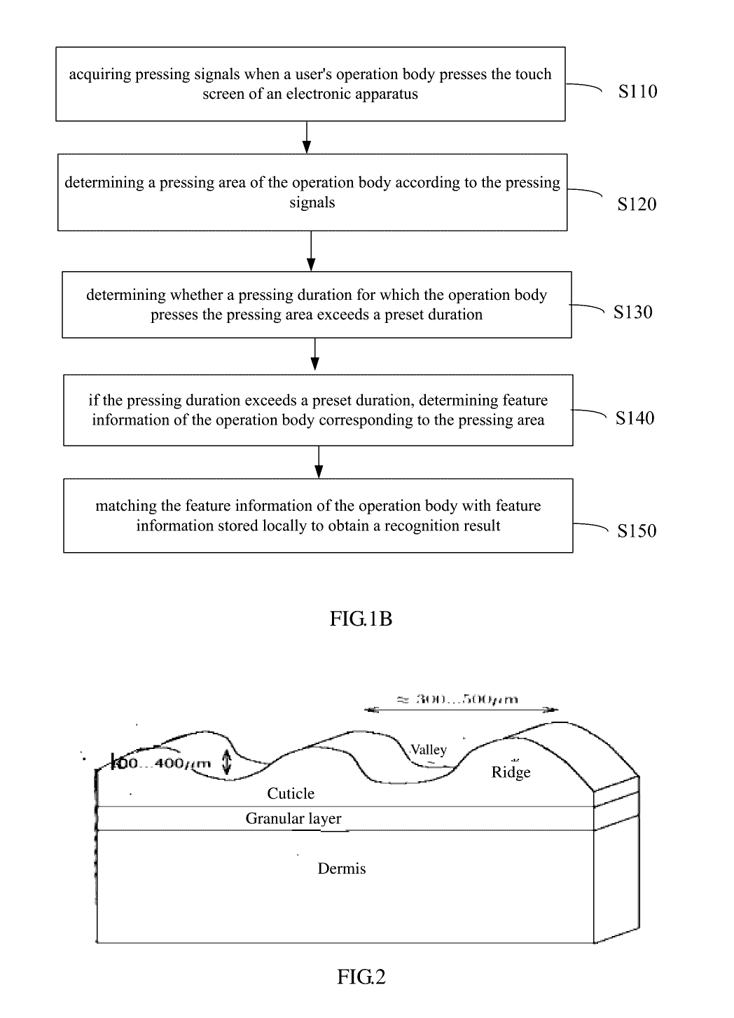

Referring to FIG. 2, which is a structural plan view of valleys and ridges, a magnitude of capacitance value is calculated according to formulae I.

$$C = \frac{ɛ S}{4 π kd} \qquad ( formulae I )$$

where C denotes capacitance, ε denotes relative dielectric constant, S denotes opposing area between two plates, k denotes electrostatic force constant, and d denotes the distance between two plates.

As can be understood from formulae I, the magnitude of capacitance variation is inversely proportional to the distance. When a palm touches the touch screen, valleys of the palm are farther from sensing signal lines in the touch screen, while ridges of the palm are closer from sensing signal lines in the touch screen. According to formulae I, when valleys of the palm absorb partial electrical signals on the sensing electrodes, since valleys of the palm are farther from sensing signal lines, capacitance between valleys and sensing signal lines is small, which can be interpreted that valleys of the palm absorb less electrical signals on the sensing signal lines. On the contrary, when ridges of the palm absorb partial electrical signals on the sensing electrodes, since ridges of the palm are closer to the sensing signal lines, which makes the capacitance between ridges of palm and the sensing signal lines large, and this can be interpreted that ridges of palm absorb more electrical signals on the sensing signal lines.

When a palm presses the touch screen, the palm absorbs part of electrical signals on the sensing signal lines, which makes the electrical signals on the sensing signal lines decrease, thereby making capacitance value between the sensing signal line and the driving signal line corresponding to the sensing signal line decease. Specifically, it can be understood that valleys of the palm contact the touch screen and absorb partial electrical signals on the sensing signal lines, and since valleys are farther from the touch screen, which allows less electrical signals on the sensing signal lines to be absorbed, thereby capacitance values between a sensing signal line and a driving signal line corresponding to the sensing signal line decreases less, which makes the capacitance value greater than a preset capacitance value. Accordingly, ridges of the palm contact the touch screen and absorb partial electrical signals on the sensing signal lines, and since ridges are farther from the touch screen, which allows more electrical signals on the sensing signal lines to be absorbed, thereby capacitance value between the sensing signal line and the driving signal line corresponding to the sensing signal line decreases more, making the capacitance value less than a preset capacitance value.

It is to be noted that, for touch screens for high resolution and high quality images, it is possible to use these feature information such as main lines, folds, mastoid process textures, fine nodes or trigonometric points of the palm as necessary features for palm print recognition. For touch screens for low resolution and low quality images, it is possible to use only main lines and folds of the palm as necessary features for palm print recognition.

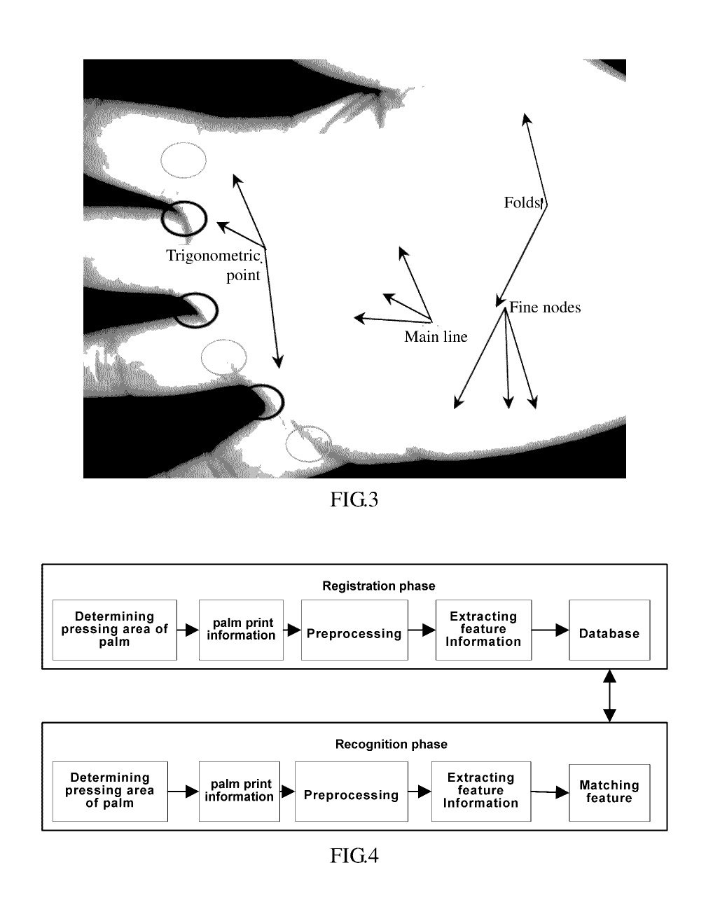

With referring to FIG. 3, main lines refer to the strongest and thickest lines on the palm, most palms have three main lines, namely life line, sentiment line and wisdom line; folds refer to lines that are thinner than main lines, shallower than main lines and are irregular; mastoid process textures refer to textures same as fingerprints; the trigonometric points are the center points of the triangular areas formed by mastoid process textures on the palm, which are located at positions under finger roots and the middle finger and close to the wrist; fine nodes refer to textures other than main lines, folds, mastoid process textures and trigonometric points in the palm print.

In addition, in the palm print recognition process in embodiments of the present disclosure, it is necessary to register palm print information in the system in advance, and the registration process and palm print recognition process are identical. The system includes a database for storing palm print information and accessible via for example a computer network.

As illustrated in FIG. 4, the user's palm information needs to be registered before the palm print recognition phase and recorded into a local database or a online database. For example, the registration process may include: acquiring palm pressing signals first and determining a palm pressing area (or a palm area) according to the palm pressing signals; determining palm print information of the palm corresponding to the palm pressing area, including information about valleys and ridges of the palm print; then converting analog signals for the information about valleys and ridges of palm into digital signals; extracting feature information of the palm via preprocessing such as signal amplification; and finally recording the palm's feature information into a local database. The palm print recognition phase may include: acquiring palm pressing signals first and deterring a palm pressing area according to the palm pressing signals; determining palm print information of the palm corresponding to the palm pressing area, including information about valleys and ridges of the palm print; extracting feature information of the palm via preprocessing; finally matching the extracted feature information and the locally or on-line stored feature information and determining the result of palm print recognition according to the result. The palm print recognition phase can succeed in palm print recognition only of the registration phase is completed. That is, palm print recognition can only be carried out when feature information of the palm is recorded in the database via the registration process, and palm print recognition will not succeed without registration process.

Step S103 is for example conducted by determining the functional module selected by the palm according to the position of the palm pressing area when the pressing duration of palm pressing area does not exceeds the preset duration, such as selecting playing music, playing video, selecting web browser, accessing Internet, querying network information, etc.

In addition, the palm print recognition method provided in embodiments of the present disclosure is also applicable to fingerprint identification, and as long as the recognition methods are the same, they all belong to the scope of embodiments of the present disclosure.

For example, the palm print recognition method of embodiments of the present disclosure may further include: when it is determined that the palm feature information corresponding to the palm pressing area does not match the locally stored feature information, the palm print recognition fails, and when the palm print recognition fails for times exceeding a preset value, an alarm is activated.

The preset value in embodiments of the present disclosure is set on demand according to requirements, for example set to 3 or 4 times. This is not limited specifically in embodiments of the present disclosure.

When the palm print recognition fails, and the failure times exceed a preset value, an alarm is triggered, thereby improving security of the palm print recognition process. It is to be noted that it's also possible to store palm print feature information of failed palm print recognition in the system, or upload the palm print feature information of failed palm print recognition onto the Internet, for reminding the user of the invalidity of the palm print.

For example, the palm print recognition method according to embodiments of the present disclosure may further include: displaying information that needs to be displayed when no palm pressing signal is received.

For example, when no palm pressing is detected, pure display is enabled, here it is possible to normally display dynamic pictures to facilitate the user to experience more, such as displaying amusement programs such as movie and TV shows.

In summary, with the palm print recognition method provided in embodiments of the present disclosure, the palm pressing signals are acquired first, and the palm pressing area is determined according to the palm pressing signals, then the palm print feature information corresponding to the palm pressing area is determined, and finally the palm print recognition succeeds when the determined palm feature information matches the locally stored feature. When the pressing duration of the palm pressing area does not exceeds the preset duration, the touch position corresponding to the palm pressing area is determined. Therefore, it is possible both implement palm print recognition and implement touch control, as well as improve the efficiency and accuracy of palm print recognition by determining palm pressing area first and then determining palm print.

With referring to FIG. 5A, a palm print recognition device provided in an embodiment of the present disclosure includes a determining unit 51, a palm print recognition unit 52 and a touch unit 53.

The determining unit 51 is configured to acquire palm pressing signals, determine the palm pressing area according to the palm pressing signals and determine whether the pressing duration of the palm pressing area exceeds a preset duration. The palm print recognition unit 52 is configured to determine palm feature information corresponding to the palm pressing area when the pressing duration of palm pressing area exceeds the preset duration, and when it is determined that the palm feature information matches locally stored feature information, the palm print recognition succeeds. The touch unit 53 is configured to determine the touch position corresponding to the palm pressing area when the pressing duration of the palm pressing area does not exceeds the preset duration.

The determining unit 51, the palm print recognition unit 52 and the touch unit 53 may be implemented at least partly in software, hardware and firmware.

The palm print recognition device of the embodiments of the present disclosure can implement palm print recognition operation: acquiring palm pressing signals first, and determining palm pressing area according to the palm pressing signals, and then determining the palm feature information corresponding to the palm pressing area when the pressing duration of palm pressing area exceeds a preset duration, and finally the palm print recognition succeeds when the determined palm feature information matches the locally stored feature information. When the pressing duration of the palm pressing area does not exceeds the preset duration, the touch position corresponding to the palm pressing area is determined Therefore, it is possible both implement palm print recognition and implement touch control, as well as improve the efficiency and accuracy of palm print recognition by determining palm pressing area first and then determining palm print.

For example, the determining unit 51 acquires palm pressing signals first and determine a palm pressing area according to the palm pressing signals. For example, if signal values on a plurality sets of sensing signal lines are acquired, and each set of sensing signal lines in the plurality sets of sensing signal lines and the driving signal lines corresponding to the sensing signal lines have different signal values therebetween, it is determined that there is a palm pressing, and the palm pressing area is acquired by positions of the plurality sets of sensing signal lines.

For example, in each set of sensing signal lines, a plurality of sensing signal lines are connected by a second multiplexer to provide a width of 3 mm-5 mm. In each set of driving signal lines, a plurality of driving signal lines are connected by a first multiplexer to provide a width of 3 mm-5 mm.

For example, the palm print recognition unit 52 determines the palm feature information corresponding to the palm pressing area. For example, if the pressing duration of the palm pressing area exceeds a preset duration, a set of sensing signal lines connected with the second multiplexer are controlled to connect sensing scanning signals in turn, and a set of driving signal lines connected with the first multiplexer are controlled to connect driving scanning signals in turn. Information on valleys and ridges of palm is determined according to the variation magnitude of capacitance values of capacitance between a sensing signal line corresponding to the palm pressing area and the driving signal line corresponding to the sensing signal line. According to the information on valleys and ridges of palm, the palm's feature information is determined, here the feature information of palm includes: main lines, folds, mastoid process texture, fine nodes and trigonometric point information.

For example, the palm pressing area is determined according to a set of sensing signal lines and driving signal lines corresponding to the set, and then each corresponding sensing signal line and the driving signal line corresponding to the sensing signal line in the palm pressing area are scanned, palm feature information corresponding to the palm pressing area is determined, which omits the process of repeated scanning of each and every sensing signal line and each driving signal line in the touch screen and thereby simplifying the palm recognition process.

For example, the palm print recognition device may further include an alarm unit configured to, when it is determined that the palm feature information corresponding to the palm pressing area does not match the locally stored feature information, determine that the palm print recognition fails, and when the palm print recognition fails for times exceeding a preset value, trigger an alarm. With the alarm unit, the security of palm print recognition process is enhanced. The alarm unit may be implemented by a speaker or a display for example.

For example, the palm print recognition device may further include a display unit for displaying information that needs to be displayed when no palm pressing signal is received. The display unit may be a display device such as an LED, OLED and the like. The display unit may implement display function when no palm pressing is detected.

With referring to FIG. 5B, an embodiment of the present disclosure further provides an electronic apparatus 500 including: a touch screen 510; a storage device 520 for storing computer program instructions; and a processor 530 for performing the computer program instructions stored in the memory to carry out the following steps: acquiring pressing signals upon a user's operation body pressing the touch screen; determining a pressing area of the operation body according to the pressing signals; determining whether a pressing duration for which the operation body presses the pressing area exceeds a preset duration; if the pressing duration exceeds the preset duration, determining feature information of the operation body corresponding to the pressing area; matching the feature information of the operation body with feature information stored locally to obtain a recognition result. That is, the processor 530 in the electronic apparatus 500 can be configured to process the procedure of the operation body information recognition method illustrated in FIG. 1B. In the following embodiments of the present disclosure, the electronic apparatus refers to an apparatus capable of communicating with another apparatus. Specific forms of the electronic apparatuses include, but not limited to a mobile telephone, a personal computer, a digital camera, a personal digital assistant, a portable computer, a game machine, or the like.

### Embodiment II

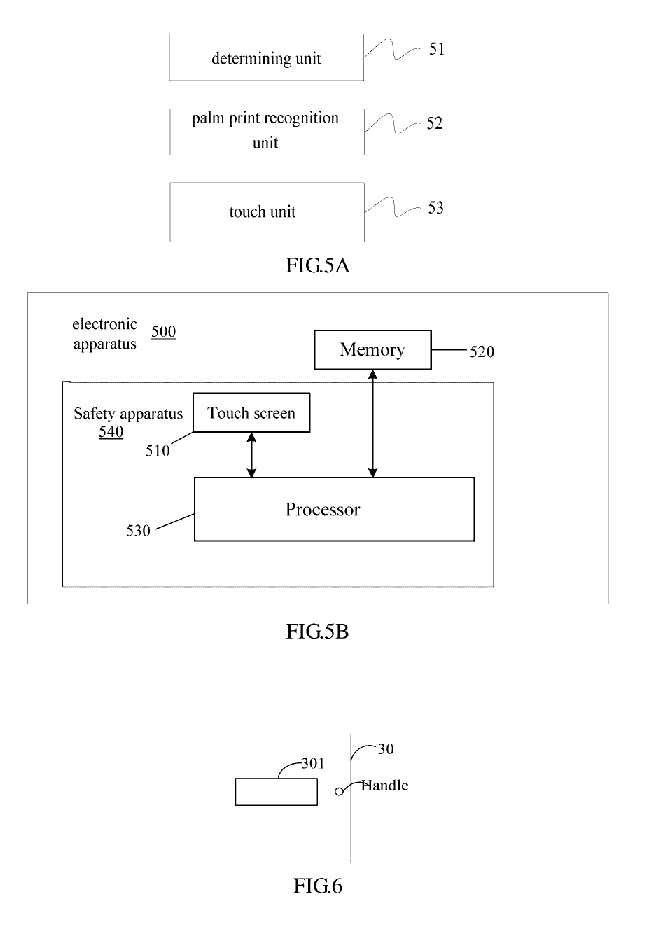

With referring to FIG. 6, an embodiment of the present disclosure provides a safety apparatus such as an intelligent safety gate 30 including a touch screen 301 and a palm print recognition device provided in an embodiment of the present disclosure. With the palm print recognition device in the safety apparatus, it is possible to open the safety gate when the palm print recognition succeeds, and keep closing the safety gate when the palm print recognition fails, and at the same time it is also possible to implement touch and display, which is in favor of improving security of the safety apparatus and realizing versatility. In addition, as illustrated in FIG. 5B, according to another example of the present disclosure, the safety apparatus 540 may further include a touch screen 510 and a processor 530 in the electronic apparatus 500, here the processor 530 can for example implement the above-mentioned palm print recognition device and implement operation body information recognition process of the flow illustrated in FIG. 1B.

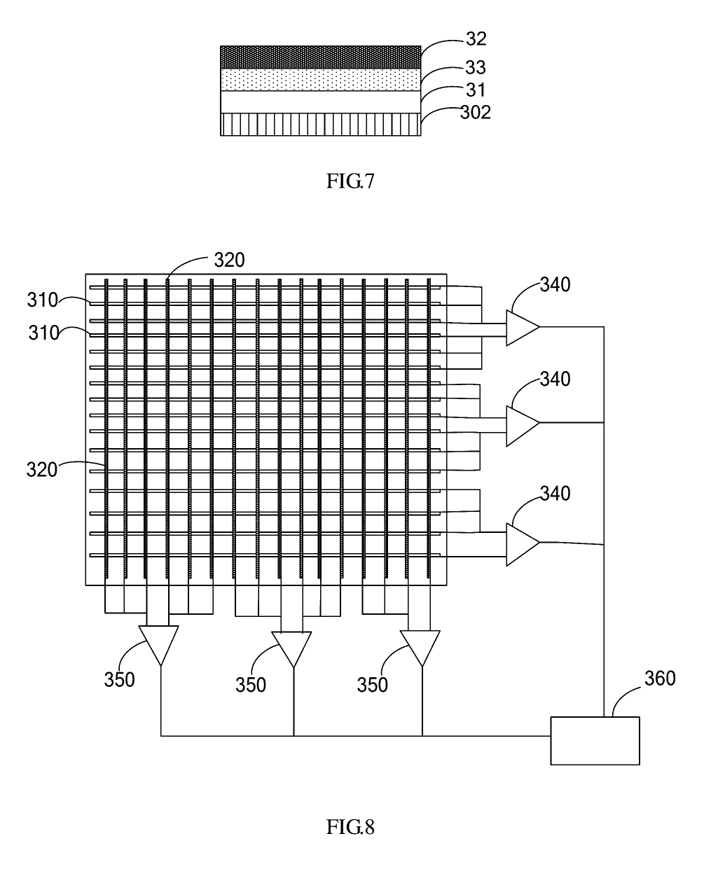

With referring to FIG. 7, the touch screen provided in an embodiment of the present disclosure includes: a driving electrode layer 31 on the black matrix 302 at the inner side of a color filter substrate, a sensing electrode layer 32 on the driving electrode layer, and an insulating layer 33 between the driving electrode layer 31 and the sensing electrode layer 32. With referring to the top view of touch screen in FIG. 8, the driving electrode layer 31 includes a plurality sets of driving signal lines 310 arranged in the first direction, and the sensing electrode layer 32 includes a plurality sets of sensing signal lines 320 arranged in the second direction (FIG. 8 illustrates only a set of sensing signal lines including six sensing signal lines as an example, however in practical applications, a set of sensing signal lines include not only six sensing signal lines).

In the embodiment of the present disclosure, it is determined whether a palm is pressing the touch screen by the variation of capacitance between a plurality sets of sensing signal lines and driving signal lines corresponding to the plurality sets of sensing signal lines in the touch screen. When it is determined the duration for which the palm presses the touch screen exceeds a preset duration, palm feature information corresponding to the palm pressing area is determined for palm print recognition according to the magnitude of variation of capacitance value between each sensing signal line corresponding to the palm pressing area and the driving signal line corresponding to the sensing signal line. Therefore, palm print recognition function is realized, and the touch screen does not affect display by disposing a plurality of sensing signal lines and a plurality of driving signal lines in the black matrix region.

For example, each set of driving signal lines 310 are signal lines with a width of 3 mm-5 mm formed by connecting a plurality of driving signal lines 310 by a first multiplexer 340, and each set of sensing signal lines 320 are signal lines with a width of 3 mm-5 mm formed by connecting a plurality of sensing signal lines 320 by a second multiplexer 350. Setting the width of each set of driving signal lines or each set of sensing signal lines to 3 mm-5 mm does not influence the touch function of the touch screen.

It is to be noted that the numbers of first and second multiplexers will be different for touch screens of different sizes. The larger the size of touch screen, the more first and second multiplexers are needed.

A multiplexer is an comprehensive system generally including a certain number of data inputs and a single output. The multiplexer in embodiments of the present disclosure includes for example a single input end and a plurality of output ends. There are many types of multiplexers, and this is not limited specifically in embodiments of the present disclosure.

The first and second multiplexers may the same as each or different from each other. In embodiments of the present disclosure, in order to differentiate the multiplexer for connecting sensing signal lines and the multiplexer for connecting driving signal lines, they do not use a same multiplexer. Therefore the first multiplexer is configured to connect a plurality of driving signal lines 310 and a digital chip 360, and the second multiplexer is configured to connect a plurality of sensing signal lines 320 and the digital chip 360.

The connection manner in embodiments of the present disclosure may be the following manners. An input end of the first multiplexer 340 is connected to an output end of the digital chip 360, a plurality of output ends of the first multiplexer 340 are connected to a plurality of driving signal lines, the first multiplexer 340 includes a plurality of thin film transistors (TFTs) inside, and the number of TFTs is in a one-to-one correspondence relationship with output ends of the first multiplexer, and each TFT is configured to control connection and disconnection between the driving signal line for connecting the TFT and the digital chip. An input end of the second multiplexer 350 is connected to an output end of the digital chip 360, a plurality of output ends of the second multiplexer 350 are connected to a plurality of sensing signal lines, the second multiplexer includes a plurality of TFTs inside, and the number of TFTs is in one to one correspondence with output ends of the second multiplexer, and each TFT is configured to control connection and disconnection between the sensing signal line for connecting the TFT and the digital chip 360.

In addition, each driving signal line has its one end connected with the first multiplexer and another end connected with the input end of the digital chip for feeding back signals of the driving signal line to the digital chip, each sensing signal line has its one end connected with the second multiplexer and another end connected with the input end of the digital chip for feeding back signals of the sensing signal line to the digital chip.

In embodiments of the present disclosure, for example, both the sensing signal lines and driving signal lines are connected to provide a width of 3 mm-5 mm for realizing the size of normal finger touch.

The driving electrode layer and the sensing electrode layer in the touch screen are located on the black matrix region for better display and touch as well palm print recognition while not influencing the aperture ratio.

It is to be noted that in order to facilitate a palm to contact sensing signal lines more easily while pressing the touch screen, the sensing electrode layer and the driving electrode layer may be on the inner side of cover glass.

Preferably, the first direction and the second direction are perpendicular to each other.

It is to be noted that when the first direction is a transverse direction and the second direction is a vertical direction, the driving signal line 310 extends in the vertical direction, and the sensing signal line 320 extends in the transverse direction. When the first direction is a vertical direction and the second direction is a transverse direction, then the driving signal line 310 extends in the transverse direction, and the sensing signal line 320 extends in the vertical direction. The first direction is specifically which direction is not limited specifically in embodiments of the present disclosure.

Preferably, the spacing between two adjacent driving signal lines and the spacing between adjacent two sensing signal lines are both 30 μm.

Generally, with referring to FIG. 2, valleys and ridges generally have a width of 300-500 μm. Since information on valleys and ridges needs to be acquired for palm print recognition, in order to more accurately recognize palm print information, both the spacing between two driving signal lines and spacing between two adjacent sensing signal lines are set to 30 μm.

Preferably, the above-mentioned safety apparatus may further include a digital chip 360 both connected with the first and second multiplexers.

When the safety apparatus is in the display phase, the digital chip 360 controls the plurality of driving signal lines 310 connected with the first multiplexer 340 and the plurality of sensing signal lines 320 connected with the second multiplexer to be grounded.

When the safety apparatus is in the touch phase, the digital chip 360 controls the plurality of driving signal lines 310 connected with the first multiplexer 340 to be all connected with driving signals, and the plurality of sensing signal lines 320 connected with the second multiplexer 350 to be all connected with sensing signals.

When the safety apparatus is in palm print recognition, the digital chip 360 controls the plurality of driving signal lines 310 connected with the first multiplexer 340 to be connected with driving scanning signals in turn, and the plurality of sensing signal lines 320 connected with the second multiplexer 350 to be connected with sensing scanning signals in turn.

The operating principle of the multiplexer in embodiments of the present disclosure is as follows. When the touch screen is in display phase, the digital chip 360 controls all TFTs in the first multiplexer 340 and the second multiplexer 350 to be turned on, and the digital chip 360 outputs a low level signal to the first and second multiplexers, thereby allowing all sensing signal lines and driving signal lines in the touch screen to be grounded.

When the touch screen is in touch phase, the digital chip controls all TFTs in the first and second multiplexers to be turned on, and the digital chip outputs driving signals to the first multiplexer, the digital chip outputs sensing signals to the second multiplexer. Under the action of the first multiplexer, the digital chip simply input driving signals to each input end of the first multiplexer, and needs not input signals to each driving signal line, thereby reducing the number and time of inputting driving signals and in turn reducing power consumption of the touch screen. Similarly, under the action of the second multiplexer, the digital chip simply inputs sensing signals to each input end of the second multiplexer, and needs not input signals to each sensing signal line, thereby reducing the number and time of inputting sensing signals and in turn reducing power consumption of the touch screen.

When the touch screen is in palm print recognition phase, the digital chip controls the plurality of TFTs in the first multiplexer to be turned on in turn, thereby scanning the plurality of driving signal lines of the first multiplexer in turn. Because the touch screen includes a plurality of first multiplexers, these first multiplexers may scan one driving signal line connected in each first multiplexer at the same time. For example, at the same time instant, each first multiplexer can scan the first driving signal line connected with the multiplexer, thereby saving time for scanning driving signal lines. Similarly, the digital chip controls the plurality of TFTs in the second multiplexer to be turned on in turn, thereby scanning the plurality of sensing signal lines in the second multiplexer in turn. Since the touch screen includes a plurality of second multiplexers, these second multiplexers may scan one sensing signal line connected in each second multiplexer at the same time. For example, at the same time instant, each second multiplexer can scan the second driving signal line connected with the multiplexer, thereby saving time for scanning sensing signal lines.

It is to be noted that each touch screen includes a plurality of sensing signal lines and a plurality of driving signal lines. For example, each first multiplexer can connect 10 driving signal lines and each second multiplexers can connect 10 sensing signal lines. That each multiplexer connects with how many driving signal lines or how many sensing signal lines is dependent on the width of each sensing signal line and the distance between adjacent sensing signal lines.

In summary, with the first multiplexer and the second multiplexer in embodiments of the present disclosure, when there is no palm pressing the touch screen, the digital chip transmits a low level signal to the first and second multiplexer, and controls all TFTs contained in the first and second multiplexers to be turned on, thereby grounding each sensing signal line and driving signal line in the touch screen for implementing display function. When there is a palm pressing the touch screen, the digital chip transmits driving signals to the first multiplexer, transmits sensing signals to the second multiplexer, and controls all TFTs in the first and second multiplexers to be turned on, thereby connecting each sensing signal line in the touch screen to sensing signals and connecting each driving signal line to driving signals. Then, each sensing signal line inputs feedback signals to the digital chip and each driving signal line inputs feedback signals to the digital chip. The digital chip determines there is a palm pressing when it is determined there is a variation of capacitance between the sensing signal lines and the driving signal lines according to the signals fed back by each sensing signal line and signals fed back by the driving signal line corresponding to the sensing signal line, determines the palm pressing area according to the positions of the sensing signal lines and the driving signal lines, and then determines the duration of the palm pressing. When the digital chip determines that duration of palm pressing exceeds a preset duration, a scan line sequence number is transmitted according to the driving signal line and sensing signal line corresponding to the palm pressing area. Specifically, driving scanning signals are transmitted to the driving signal lines corresponding to the palm pressing area to connect them with the first multiplexer and the plurality of TFTs in the first multiplexer are controlled to be turned on in turn, thereby the plurality of driving signal lines connected with the first multiplexer are scanned in turn. Similarly, sensing scanning signals are transmitted to the sensing signal lines corresponding to the palm pressing area to connect them with the second multiplexer and the plurality of TFTs in the second multiplexer are controlled to be turned on in turn, thereby the plurality of sensing signal lines connected with the second multiplexer are scanned in turn, and the palm feature information is determined according to the scanning signals fed back by the plurality of sensing signal lines and the plurality of driving signal lines and according to the magnitude of capacitance variation between each sensing signal line and the driving signal line corresponding to the sensing signal line, thereby completing palm print recognition in turn. Therefore, the time and the number of times for transmitting driving signals and sense printers are reduced by using the multiplexers. By determining the palm pressing area first, then scanning the sensing signal lines and driving signal lines of the palm pressing area, the time and the number of times for scanning each driving signal line and each sensing signal line are reduced, and the accuracy and efficiency of palm print recognition are improved.

Of course, the safety apparatus provided in embodiments of the present disclosure is only a preferred application scenario for the palm print recognition device and touch screen provided in embodiments of the present disclosure. Of course, the palm print recognition device and touch screen provided in embodiments of the present disclosure may be applied in other products such as TV sets and tablets.

In summary, with the palm print recognition method provided in embodiments of the present disclosure, palm pressing signals are acquired first, the palm pressing area is determined according to the palm pressing signals, and then the palm's feature information corresponding to the palm pressing area is determined when the pressing duration of the palm pressing area exceeds a preset duration, and finally the palm print recognition succeeds when it is determined that the palm's feature information matches the locally stored feature information; and the touch position corresponding to the palm pressing area is determined when the pressing duration of palm pressing area does not exceeds the preset duration. Therefore, it is possible both implement palm print recognition and implement touch control, as well as improve the efficiency and accuracy of palm print recognition by determining palm pressing area first and then determining palm print.

Obviously, one skilled in the art can make various changes and variations to the present disclosure without departing from the spirit and scope of the present disclosure. Thus, if these changes and variations of the present disclosure fall within the scope of claims and equivalents of the present disclosure, it is intended that the present disclosure also include these changes and variations.

The present application claims priority of a China patent application No. 201510333850.8 filed on Jun. 16, 2015, which is incorporated in its entirety herein by reference as part of the present application.

1. An operation body's feature information recognition method, comprising:
acquiring pressing signals upon a user's operation body pressing a touch screen of an electronic apparatus;
determining a pressing area of the operation body according to the pressing signals;
determining whether a pressing duration for which the operation body presses the pressing area exceeds a preset duration;
if the pressing duration exceeds a preset duration, determining feature information of the operation body corresponding to the pressing area; and
matching the feature information of the operation body with feature information stored locally to obtain a recognition result.

2. The method of claim 1, wherein when the operation body's feature information matches the locally stored feature information, position information corresponding to the pressing area is determined; and touch signals are generated according to the position information.

3. The method of claim 1, wherein the touch screen comprises a plurality sets of sensing signal lines and a plurality sets of driving signal lines corresponding to the plurality sets of sensing signal lines,
the step of acquiring pressing signals upon a user's operation body pressing a touch screen of an electronic apparatus comprises:
acquiring signal values on the plurality sets of sensing signal lines;
acquiring signal values on the plurality sets of driving signal lines;
determining that the operation body is pressing the touch screen if signal values on each set of sensing signal lines in the plurality sets of sensing signal lines and driving signal lines corresponding to the set of sensing signal lines are different; and
generating the pressing signals according to the position information indicating signal values on each set of sensing signal lines in the plurality sets of sensing signal lines and driving signal lines corresponding to the set of sensing signal lines are different.

4. The method of claim 1, wherein the touch screen comprises a plurality sets of sensing signal lines and a plurality sets of driving signal lines corresponding to the plurality sets of sensing signal lines,
the step of, if the pressing duration exceeds the preset duration, determining feature information of the operation body corresponding to the pressing area comprises:
determining the operation body's feature information according to a variation magnitude of capacitance values of capacitance between each sensing signal line corresponding to the operation body pressing area and a driving signal line corresponding to the sensing signal line.

5. The method of claim 3, wherein the electronic apparatus further comprises a first multiplexer and a second multiplexer,
in determining that the operation body is pressing the touch screen, the method further comprises:
transmitting driving signals to the first multiplexer;
transmitting sensing signals to the second multiplexer;
controlling each sensing signal line in the touch screen to receive the sensing signals via the first multiplexer; and
controlling each driving signal line in the touch screen to receive the driving signals via the second multiplexer.

6. The method of claim 4, wherein the electronic apparatus further comprises a first multiplexer and a second multiplexer,
when it is determined that the operation body's pressing duration exceeds a preset duration, the method further comprises:
acquiring the pressing area of the operation body;
transmitting driving scanning signals to the first multiplexer connected with the driving signal line corresponding to the pressing area;
transmitting sensing scanning signals to the second multiplexer connected with the sensing signal line corresponding to the pressing area;
scanning the driving signal lines that receive the driving scanning signals via the first multiplexer in turn;
scanning the sensing signal lines that receive the sensing scanning signals via the second multiplexer in turn;
receiving scanning signals fed back by the sensing signal lines and the driving signal lines; and
determining the magnitude variation of capacitance values of capacitances between the sensing signal line and the driving signal line according to the fed back scanning signals.

7. The method of claim 1, wherein the electronic apparatus further comprises a first multiplexer and a second multiplexer, the touch screen comprises a plurality sets of sensing signal lines and a plurality sets of driving signal lines corresponding to the plurality sets of sensing signal lines, the method further comprising:
upon the touch screen not receiving the operation body's pressing signals, receiving low level signals with the first multiplexer and the second multiplexer;
grounding the sensing signal lines and the driving signal lines in the touch screen; and
displaying information with the touch screen.

8. The method of claim 1, wherein the operation body comprises a palm or a finger, and the operation body's feature information comprises: main lines, folds, mastoid process texture, fine nodes or trigonometric point of the palm or texture of the finger.

9. An electronic apparatus comprising:
a touch screen;
a memory configured for storing computer program instructions;
a processor configured for performing the computer program instructions stored in the memory to carry out steps of:
acquiring pressing signals upon a user's operation body pressing the touch screen;
determining a pressing area of the operation body according to the pressing signals;
determining whether a pressing duration for which the operation body presses the pressing area exceeds a preset duration;
if the pressing duration exceeds the preset duration, determining feature information of the operation body corresponding to the pressing area; and
matching the feature information of the operation body with feature information stored locally to obtain a recognition result.

10. The apparatus of claim 9, wherein if the operation body's feature information matches the locally stored feature information, position information corresponding to the pressing area is determined; and
touch signals are generated according to the position information.

11. The apparatus of claim 9, wherein the touch screen comprises a plurality sets of sensing signal lines and a plurality sets of driving signal lines corresponding to the plurality sets of sensing signal lines,
acquiring pressing signals upon a user's operation body pressing a touch screen of an electronic apparatus comprises:
acquiring signal values on the plurality sets of sensing signal lines;
acquiring signal values on the plurality sets of driving signal lines;
determining that the operation body is pressing the touch screen if signal values on each set of sensing signal lines in the plurality sets of sensing signal lines and driving signal lines corresponding to the set of sensing signal lines are different; and
generating the pressing signals according to position information indicating signal values on each set of sensing signal lines in the plurality sets of sensing signal lines and driving signal lines corresponding to the set of sensing signal lines are different.

12. The apparatus of claim 9, wherein the touch screen comprises a plurality sets of sensing signal lines and a plurality sets of driving signal lines corresponding to the plurality sets of sensing signal lines,
if the pressing duration exceeds the preset duration, determining feature information of the operation body corresponding to the pressing area comprises:
determining the operation body's feature information according to a variation magnitude of capacitance values of capacitance between each sensing signal line corresponding to the operation body pressing area and a driving signal line corresponding to the sensing signal line.

13. The apparatus of claim 11, wherein the electronic apparatus further comprises a first multiplexer and a second multiplexer,
if determining that the operation body is pressing the touch screen, the following steps are further carried out during the processor is running:
transmitting driving signals to the first multiplexer;
transmitting sensing signals to the second multiplexer;
controlling each sensing signal line in the touch screen to receive the sensing signals via the first multiplexer; and
controlling each driving signal line in the touch screen to receive the driving signals via the second multiplexer.

14. The apparatus of claim 12, further comprising: a first multiplexer and a second multiplexer,
if determining that the operation body pressing duration exceeds the preset duration, the processor further carries out steps of:
acquiring a pressing area of the operation body;
transmitting driving scanning signals to the first multiplexer connected with the driving signal line corresponding to the pressing area;
transmitting sensing scanning signals to the second multiplexer connected with the sensing signal line corresponding to the pressing area;
scanning the driving signal lines that receive the driving scanning signals via the first multiplexer in turn;
scanning the sensing signal lines that receive the sensing scanning signals via the second multiplexer in turn;
receiving scanning signals fed back by the sensing signal lines and the driving signal lines; and
determining variation of capacitance values of capacitances between the sensing signal line and the driving signal line according to the fed back scanning signals.

15. The apparatus of claim 9, wherein the electronic apparatus further comprises a first multiplexer and a second multiplexer, the touch screen comprises a plurality sets of sensing signal lines and a plurality sets of driving signal lines corresponding to the plurality sets of sensing signal lines, the processor further carries out steps of:
if the touch screen does not receive the operation body's pressing signals, receiving low level signals with the first multiplexer and the second multiplexer;
grounding the sensing signal lines and the driving signal lines in the touch screen; and
displaying information with the touch screen.

16. A safety apparatus comprising the electronic apparatus of claim 9.

17. (canceled)

18. (canceled)

19. (canceled)

20. The safety apparatus of claim 16, further comprising: a first multiplexer, a second multiplexer and a digital chip connected with the first multiplexer and the second multiplexer,
wherein the touch screen comprises a plurality sets of sensing signal lines and a plurality sets of driving signal lines corresponding to the plurality sets of sensing signal lines, the driving signal lines being connected with the first multiplexer and the sensing signal lines being connected with the second multiplexer,
when the safety apparatus implements display function, the digital chip controls the driving signal lines, via the first multiplexer, to be grounded, and the digital chip controls the sensing signal lines, via the second multiplexer, to be grounded;
when the safety apparatus implements touch function, the digital chip controls the driving signal lines to receive driving signals via the first multiplexer, and the digital chip controls the sensing signal lines to receive sensing signals via the second multiplexer;
when the safety apparatus implements operation body feature information recognition function, the digital chip controls the driving signal lines to receive driving scanning signals via the first multiplexer, and the digital chip controls the sensing signal lines to receive sensing scanning signals via the second multiplexer.

21. A palm print recognition device, comprising:
a determining unit configured for acquiring palm pressing signals, determining a palm pressing area according to the palm pressing signals and determining whether the pressing duration of the palm pressing area exceeds a preset duration;
a palm print recognition unit configured for determining feature information corresponding to the palm pressing area if a pressing duration of the palm pressing area exceeds a preset duration, wherein the palm print recognition succeeds when it is determined that the palm's feature information matches the feature information stored locally; and
a touch unit for, when the pressing duration of the palm pressing area does not exceeds the preset duration, determining touch position corresponding to the palm pressing area.

22. The device of claim 21 wherein the determining unit acquires palm pressing signals and determines a palm pressing area according to the palm pressing signals,
the determining unit is configured to, while acquiring signal values on a plurality sets of sensing signal lines and each set of sensing signal lines in the plurality sets of sensing signal lines and the driving signal lines corresponding to the sensing signal lines have different signal values, determine that a palm pressing occurs and acquire a palm pressing area by positions of the plurality sets of sensing signal lines.

23. (canceled)

24. (canceled)

25. (canceled)

26. (canceled)

27. A safety apparatus comprising the palm print recognition device of claim 21.
